(19) United States
(12) Patent Application Publication
(10) Pub. No.: US 2002/0046009 A1
(43) Pub. Date: Apr. 18, 2002

(54) Method for visualizing and processing process runs, and a computer program for simulating the same

(76) Inventors: Georges Devaquet, Zurich (CH); Martin Meyer ter Vehn, Waldshut-Tiengen (DE); Pavel Rihak, Baden (CH); Martin Scheu, Kuessaberg (DE); Giovanni Schnyder, Erlenbach (CH); Bernhard Weigand, Filderstadt-Sielmingen (DE)

Correspondence Address: BURNS DOANE SWECKER & MATHIS L L P, POST OFFICE BOX 1404, ALEXANDRIA, VA, 22313-1404, US

(21) Appl. No.: 09/880,864

(22) Filed: Jun. 15, 2001

(30) Foreign Application Priority Data
Jun. 21, 2000 (EP) 00112978.2

(51) Int. Cl. G06F 17/50

(52) U.S. Cl. 703/1

(57) ABSTRACT

In a method for visualizing and processing a value assembly process, the value assembly process is visualized as a set of value assembly lines (VAL) arranged on different hierarchy levels. Each value assembly line receives value packages via input interfaces and consolidates these to form a value added package (VAP), an added value being created, and makes the added value package available at an output interface. The added value package can be used by a value assembly line of a higher-order hierarchy level as input value package. Likewise, the input value packages of the value assembly lines can be value added packages made available by lower-order value assembly lines, the lower-order value assembly lines being value assembly lines of a lower-order hierarchy level. All value assembly lines and all value packages have an identical structure; only the processed data differ from one another. The self-similar fractal visualization permits transparent and modular visualization and processing of complex and widely branched value assembly processes. The method is particularly well suited for implementation in a computer program.

### TECHNICAL FIELD

The present invention relates to a method for visualizing and processing process runs of a value assembly process. The invention also relates to a computer program for simulating and illustrating a value assembly process visualized in accordance with the invention, and a method for visualizing the value assembly process on an output unit of a computer system.

The invention also relates to a computer system for carrying out the computer program according to the invention, and to a computer program product which contains the instruction sequences of the computer program according to the invention.

### PRIOR ART

In a global economy, locally distributed resources are increasingly being used for projects of all sorts. This is based on the finding that process steps can, in particular, run on lower-order planes parallel to and independently of one another. In this case, small autonomous units are substantially more flexible, and the subprocesses are easier to grasp. Such a development is rendered possible by the rapid advances in communications technology and in traffic and transportation infrastructure. Because of these developments, the rate of transportation of nonmaterial value packages—such as knowledge, information, money and services—is virtually unlimited, in conjunction with negligible costs. Modern transportation and logistics systems render possible worldwide mobility of goods and wares of actually any size and nature. The costs of mobility by comparison with the overall value assembly are frequently virtually negligible in this case.

The local diversification of value assembly which is now possible, on the one hand permits an exceptionally efficient use of resources. In addition, the value assembly is performed in small comprehensive packages, and this renders possible simple and efficient control of the value flows within these packages. On the other hand, it becomes extremely difficult to survey the overall project, since the flows of information, value, goods and the like exhibit a strongly branched structure with a multiplicity of interfaces. In this case, an overview is important for colleagues on each hierarchy level: on the one hand, the project management must preserve control over the running of the project at any time. On the other hand, it is desirable for an individual colleague or subcontractor on a lower-order level to be able to detect which influence his own activities has on a complex value assembly chain. This renders possible efficient real-time resource planning in the small self-contained packages, and promotes holistic entrepreneurial thinking by the individual colleague.

However, according to the prior art it is an extremely difficult matter to visualize such widely branched processes such as value assembly, for example, in a large project, and to process realistically data which feature on an arbitrary plane in the system, and to visualize the influence on the overall system or the overall process.

### SUMMARY OF THE INVENTION

The invention aims to provide a remedy here. As it is characterized in the claims, the invention is based on the object of specifying a method of the type mentioned at the beginning with the aid of which it is possible to visualize the process runs in a transparent way and to process them. Furthermore, the type of visualization of the basic process is to create the possibility of illustrating the overall process in a simple and flexible way in a computer program, and of simulating it. Again, it is to be possible to visualize the process for a user in a comprehensive and transparent fashion such that the value flows are clear and neatly comprehensible within the visualized project or the value assembly process.

The invention must be capable in this case to show in a clearly outlined way the transitions between the overall strategy—for example the corporate philosophy and the definition of core responsibilities—of the project planning and the project execution.

The invention must also be capable at any time of visualizing the current state of process-relevant data.

The invention must be capable of ensuring an efficient and uncomplicated flow of information in good time.

The invention must be capable of visualizing skills and accountable responsiblities.

The invention must render possible clear stipulations of aims and direct monitoring of results.

The invention must be capable of making information accessible on a process by means of interfaces which are defined neatly and in a standardized way.

The method according to the invention must illustrate a process in a way which can be visualized comprehensively.

The method according to the invention must reproduce a process credibly.

It must be possible to integrate the visualization of a process according to the invention into other contexts.

The visualization of a process according to the invention must be transparent.

The visualization of a process according to the invention must show the accountable responsibilities.

The visualization of a process according to the invention must permit an assessment of the process.

The visualization of a process according to the invention must exhibit a high level of flexibility.

The visualization of a process according to the invention must be easy to understand.

The invention as characterized in the claims makes use for the purpose of meeting the requirements set forth above of the finding that, for example, an entire project can be split up into a multiplicity of subprojects which are hierarchically organized vertically and horizontally independent. Each lower-order subproject can be visualized as a Value Assembly Line, VAL, each value assembly line VAL receiving via a number of input interfaces Input Value Packages IVP which are assembled in accordance with specific rules to form a Value Added Package, VAP, of this subproject. The specific rules are defined by a Main Line Function MLF. In this case, the value contribution is visualized inside the value assembly line in the coordinating and controlling main line function MLF. The value added package VAP is accessible from outside via an output interface of the value assembly line. The value added package VAP can then be processed further, for example in a higher-order value assembly line VAL, or be made available to the outside as information. Specifically concerning the simulation in the form of a computer program, a VAP can also be stored on a data medium or passed on to an output medium—display screen, printer and the like. In particular, a VAP can also be output onto a file and stored on a data medium and/or transported, or be made accessible via long-distance data transmission or the Internet to a higher-order VAL, or else to a user situated at another location.

The value packages—VAPs and IVPs—can contain a multiplicity of information. In order for the value packages VAPs and IVPs to be surveyed and handled more effectively, they are advantageously subdivided into classes which in each case contain only the relevant data. Thus, for example, a specific class of value packages will contain all data of cost relevance for the project, a further class will contain data of quality relevance, etc. However, reference is generally made below to a single value package in each case, in order not to complicate unnecessarily the visualization of the state of affairs in this approach. The person skilled in the art will have no difficulty in generalizing to a plurality of classes of value packages, that is to say a plurality of classes of VAPs and IVPs.

It is particularly characteristic of the invention that identical types of information are transmitted in input value packages IVPs and in value added packages VAPs. Thus, although information in different VAPs and IVPs of the same class differs quantitatively, the information content is always identical qualitatively. When referred to a computer program, this means that the IVPs and the VAPs are present in standardized data forms. The data structure of these data forms, which can be present as a file, always remains the same. Thus, the same types of data are always stored at the same position in the data record, while the quantitative content of the files differs in each case. Thus, for example if the information concerning processing steps completed or concerning costs is stored at a specific position in an IVP of a class, it will be located at the same position again in another IVP or VAP of the same class.

The invention can also be considered as an analytical top-down approach, as by a synthetic bottom-up approach. In broad terms, in the top-down approach an entire project or a complex process is visualized as a number of subprojects of a lower-order hierarchy level whose value added packages VAPs are assembled in a value assembly line VAL to form a VAP of the higher hierarchy level. VAPs of a lower-order hierarchy level thereby simultaneously visualize input value packages IVPs of a VAL of the next higher hierarchy level. On the highest hierarchy level N, the output value of a VAL is the final result of the overall process under consideration, for example the turnover of an overall project. On a hierarchy level N-1 therebelow, lower-order value assembly lines, Sub Assembly Lines SALs, generate the VAPs of the lower-order hierarchy level N-1, which visualize simultaneous IVPs of the hierarchy level N. It is possible to this extent to go over from the highest hierarchy level N to the lower hierarchy level N-1. The SALs of the higher hierarchy level themselves again visualize VALs on this lower hierarchy level. A number of VALs exist on the hierarchy level N-1. The VAPs of these VALs are certainly influenced by their SALs and passed on as such to the higher-order VALs; however, the VALs of a hierarchy level do not influence one another. Furthermore, a VAL of a lower-order hierarchy level does influence a VAL of a higher-order level, but the VAL of a higher-order level has no influence on the value assembly in the lower-order hierarchy levels. The flow of the value packages within the system is therefore directional. The VALs are therefore denoted as horizontally independent and vertically dependent in one direction.

It is characteristic of the analytical top-down approach that the starting point is a very strongly integrated project phase, for example the project turnover. A higher added value is created in this phase. The flows of the value packages are now investigated in this highly integrated project phase. It is established in this case that on the highest hierarchy level a VAL assembles a number of value packages IVPs, which value packages stem from SALs. The focus is on a specific SAL. This SAL can be visualized one level lower in a similar fashion as VAL, which for its part receives IVPs from a number of SALs, and a VAP can be generated from them. A complex process can be branched ever more deeply in this way. However, on all hierarchy levels the focus is on small, transparent subunits, precisely the VALs of this hierarchy level and their SALs. Since no horizontal dependence is given, each of the subprocesses can really be handled per se in a transparent framework without firstly examining the complex overall structure.

Particular mention may be made of the fact that the branched subprocesses are all structurally similar to one another. Consequently, this is a fractal system, that is to say with each change in scale and further focusing on a subprocess, the latter is once again completely similar to the previously considered higher-level subprocess. All subprocesses of a hierarchy level are likewise similar.

Depending on the branch of the value assembly process followed, this analytical procedure is followed further down to a depth which is to be established more or less arbitrarily and also depends in general on the branch of the value assembly process followed. If a production process is considered, for example, the lowermost hierarchy level constitutes the production and/or value assembly depth under consideration.

This procedure may be explained in a very simplified fashion in a rough overview using the example of the production of a motor vehicle. The finished motor vehicle visualizes the VAP of the highest hierarchy level in this case. The IVPs are the body, drive train and running gear, and the final assembly line visualizes the VAL of the highest hierarchy level. The assembly of the running gear, the body assembly and the assembly of the drive train are SALs of the highest hierarchy level. If, now, the focus is by way of example on the assembly of the running gear, this visualizes a VAL of the next lower hierarchy level; the mounted running gear is the VAP thereof. The SALs of this hierarchy level are the mounting of the wheels, the wheel suspension and the steering. The manufacturer can now regard a wheel as a bought-in part whose production lies outside his core responsibilities. Further analysis is then terminated on this process branch, and the wheel is regarded as a given value package delivered into the value assembly process on this hierarchy level. The value assembly depth on this specific branch is thereby defined, while, by way of example, the mounting of the wheel suspension can still be regarded on a lower level as being within one's own responsibilities. It may be seen from this example that within the context of the invention to speak of a lowermost hierarchy level is to use a relative term. In fact, defining where the limits of one's own responsibilities are to be drawn is a more or less arbitrary matter here. Nevertheless, it will be impossible within the scope of the present invention to avoid referring to a lowermost hierarchy level as reference point in the claims, as well. On the basis of the statements made above, the person skilled in the art will now be capable of correctly fitting this term into the overall context, and of recognizing, specifically, that a reference point is involved. This will be explained once more under “Summary of the invention”. Theoretically—and this lies in the nature of a fractal system—the refinement can be followed further straightaway ad infinitum; of course, limits must be drawn in practice. With reference to the example adduced above, it can also be regarded as sensible for logistic reasons for a subcontractor who supplies said wheel also be included in the analysis of the value assembly process. Of course, this displaces the lowermost hierarchy level once more. On the plane of this subcontractor, mounting the tire on the rim is a VAL, the wheel is a VAP, and the tire and the rim are the value packages, which are handed over by SALs to the VAL. The subcontractor could also undertake a further analysis of his process and dismount onto the level of the rim production, a new lower-order hierarchy level arising in this case. On this hierarchy level of even lower order, the rim production would then in turn be the VAL and the rim the VAP, and the production of any sort of semifinished products would need to be illustrated as SALs.

It becomes clear from this that the analytical approach in applying the invention can theoretically be continued ad infinitum in identical fashion per se as a decomposition of the process and all subprocesses into ever new, self-similar subpackages. This property of the invention is of central importance and is a central property of fractal systems: the process branches into ever finer structures. On each hierarchy level, a VAL has a structure resembling that of a main branch, the SALs being the branches thereof. It is true that the contents of the individual branches changes when the focus is on a lower hierarchy level, but the structure of the focused VAL remains the same. It is only on a hierarchy level which is the lowest by definition that there is, as it were, a break in the self-similarity. There, the value packages IVPs are no longer transferred to the VAL from the lower-order value assembly lines SALs, but are brought in from outside the process, as it were across the boundaries of the control space or the system boundaries of the value assembly process under consideration. However, the structure of the VAL itself is not changed thereby. This corresponds to the thinnest branches in the case of using a tree for considering similarity. These have the same structure as the thicker main branches and branches, but carry leaves instead of yet thinner branches.

The synthetic bottom-up approach starts on the plane of the abovementioned subcontractor. Thus, a subcontractor or any desired Process Owner Team, POT, can firstly depict his own subprocess in a selfcontained form. This can be done by all POTs on a lower-order plane. In this case, they can firstly take the IVPs of their VAL as given and flowing into their subprocess from outside. That is to say, firstly each Process Owner, PO, can visualize his own subprocess in a very transparent fashion, and determine his VAP as a function of the IVPs. This VAP is supplied to the outside again with reference to the specific subprocess. VAPs of a hierarchy level then serve in turn as input value packages, IVPs, of a VAL of a higher hierarchy level. A PO of a higher hierarchy level can therefore, in turn, illustrate his VAL very simply by using the VAPs of the lower hierarchy level as IVPs, and the SALs of the lower hierarchy level as VALs. The self-similarity of the subprocesses on different hierarchy levels permits a modular design of the overall process.

The core of the invention in this case is to visualize all VALs and SALs as self-similar, fractal processes. Accordingly, the visualization of the VALs is performed in such a way that suprocesses on each hierarchy level are illustrated in a completely identical way as a VAL and a number of SALs. The SALs provide value packages at input interfaces of the VAL. These value packages are assembled in the VAL, and a value added package VAP which makes the VAL available at an output interface is generated. In this case, there is inherent in the VAL a controlling, coordinating function which determines which value packages are assembled in which way. This is denoted as the main Main Line Function, MLF, and represents the actual value contribution. In the case of further process synthesis, the VAP can be used directly as IVP for a VAL of a next higher hierarchy level, this VAL being structurally of identical design to the VAL of hierarchy level therebelow. Furthermore, the VAP of a VAL of a specific hierarchy level is used as input value package IVP of precisely one VAL of a higher-order hierarchy level. This context, too, underscores that there is no crossconnection between VALs of a specific hierarchy level, including in the form of multiple value flows.

The relevance of self-similarity to the invention likewise becomes clear in the analytical approach to a subprocess. A subprocess on a hierarchy level N includes a VAL and its SALs in the way described above. One hierarchy level lower is reached upon changing the scale and focusing on one of the SALs. The SAL which has been focused on in a level N is a VAL of level N-1 upon transition to the lower hierarchy level and contains in a likewise identical way a number of SALs whose results are combined to form a VAP.

On the basis of the self-similar, fractal structure, implemented in accordance with the invention, of the process visualization, it becomes very easy to visualize the process in a computer system. The implementation in a computer program can likewise be performed in a simple way, since, after all, all VALs are of similar design and have an identical structure of the input and output data, specifically the VAPs and the IVPs. In principle, the entire program, which is required for illustrating and simulating a complex process, can be created from a single source code. It is then possible to use different parameter blocks PB to define from which data blocks a routine illustrating a VAL reads in IVPs, in which way these are combined with one another, and in which data block the VAP thus produced is stored. The costs arising and/or the required outlay on time for “traversing” the value assembly line can also, in particular, belong to the combining rules which bring the parameter block into the value assembly line. The function of the parameter block PB corresponds by and large to the function of the main line function MLF.

The data which are stored in the data blocks and are transferred via the latter from a lower-order into a higher-order VAL can be, for example, money, plant components, quality, resources, staff, information, documentation and the like. It is sensible in this case to subdivide the value packages into various classes such as, for example, costs, time, quality, components, responsibilities and the like. As mentioned, the value added packages VAPs of a value assembly line VAL are output into standardized forms. There is no problem in mastering the transfer of value packages between value assembly lines of different hierarchy levels because of the standardized data format, thus achieved, at least of classes of value added packages.

It is advantageous in each case to implement a warning function Early Warning System, EWS, at the output interface of a VAL. The warning function compares the VAP of this VAL with the desired value. An alarm is triggered in the event of critical deviations Non Conformance, NC. Thus, deviations from the project planning which put the achievement of the goal—handover instant, profit, quality—at risk can already be detected and localized at an early stage, and appropriate countermeasures can be instituted. The method according to the invention is advantageous, here, as well, since the success and other consequences of countermeasures, such as their influence on costs and quality, can be checked immediately with the aid of a simulation of the process.

The standardized data form advantageously implemented renders possible both a simple and comprehensive visualization of the value assembly process, that is to say of the VALs and SALs on different hierarchy levels, and a simple visualization of the VAPs, for example an overview of all VAPs of a class on a hierarchy level, or a visualization of a VAP of a class on a hierarchy level as consolidation of all sub-VAPs of the lower-order hierarchy level.

The simplicity of subpackages of the system ensures that the computer program and the computer system are outstandingly clear. A modular and structured design of the computer program can be implemented in a simple way from subprograms which visualize similar subprocesses. Changes and/or supplements can be undertaken in a very simple way because of the self-similar fractal way of visualizing a process or, in general, a value assembly process, and the strictly modular design of a computer program thus implemented. If, for example, additional value flows are to be visualized, it suffices firstly to change the source code of those routines which visualize the VALs, to transfer said code onto the multiplicity of VALs of the various hierarchy levels, and to combine it there with the subprocess-specific parameters.

It may be expressly mentioned at this juncture that the term “computer program” is, of course, to be understood here in its widest meaning. This is to be understood in the present context such that any type of computer-readable instruction sequences which are suitable—alone or in conjunction with programs familiar to the person skilled in the art—for prompting a computer to execute the described method steps can constitute the computer program. These can be instruction sequences which can be executed directly, or else a source text of a program which has been written in a high-level language such as, for example, FORTRAN or C, and requires a compiler program before it is executed. Furthermore, the configuration of tabular calculations or database programs which are known per se, for the specific task, for example, also fall into this category, just as do suitable programming of script processing, and further means, familiar to the person skilled in the art, for programming a computer or a computer system. The source code of the computer program is then likewise to be understood in the most widely adopted sense as the editable versions of the instruction sequences, that is to say, for example, also tables of tabular calculation programs whose fields contain data which are suitable for prompting the computer to execute the method steps described when the table is processed by the tabular calculation program.

Because of the specific properties of the visualization according to the invention of value assembly processes, a computer program which illustrates a value assembly process in a way according to the invention can also run very effectively in divided systems. The standardized interfaces permit the VAPs to be transferred as files without difficulty even between different computers which are cited at different locations. Thus, a globally distributed value assembly process really can also be illustrated with the aid of globally distributed resources. Production units and POTs which operate at different locations can simulate their share of the value assembly process directly on the spot. In this case, program routines which simulate a local VAL can be integrated into the management of the local POT, for example of a subcontractor or of a secondary works. The VAP generated there can then be transmitted as a file via long-distance data lines, via the Internet, or by means of a data medium to a computer on which a higher-order VAL is illustrated. In consequence, therefore, each VAL can be illustrated for the respective POT, and the illustration of this VAL can be integrated in the computer system of the respective POT. A POT can therefore take over the full responsibility for its VAL. The computer system of the POT in this case receives the IVPs at least partially via the standardized interface by long-distance data transmission, and passes on the generated VAP via the output interface as a file in a standardized format to a higher-order VAP, it being directly possible here, as well, for long-distance data transmission to be involved.

The invention in this case also very particularly advantageously renders possible transparent types of visualizing the process for the user.

Further advantageous designs of the idea of the invention present themselves to the person skilled in the art with regard to the exemplary embodiments and the patent claims specified below.

### BRIEF DESCRIPTION OF THE DRAWING

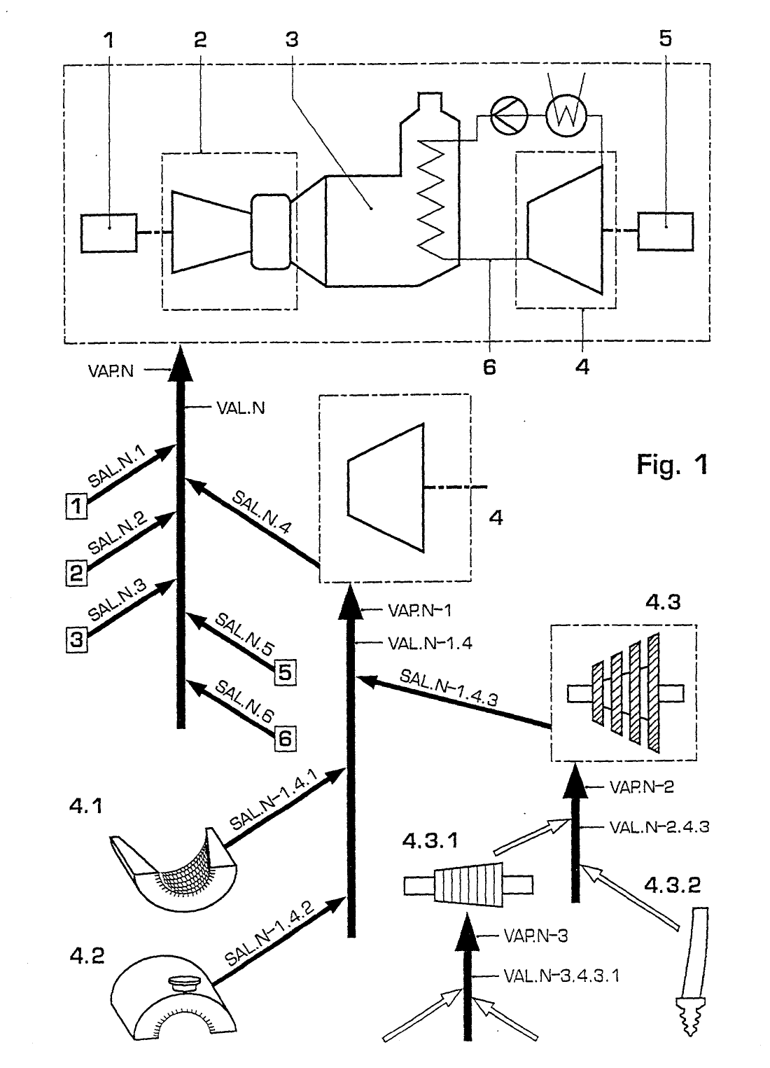

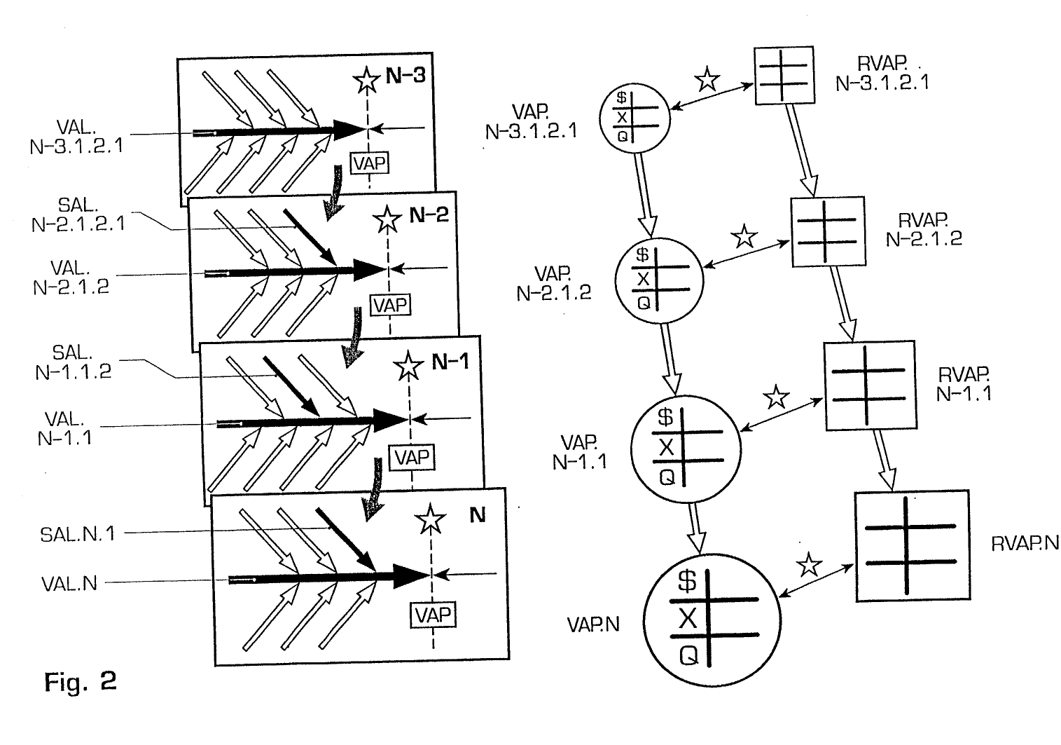

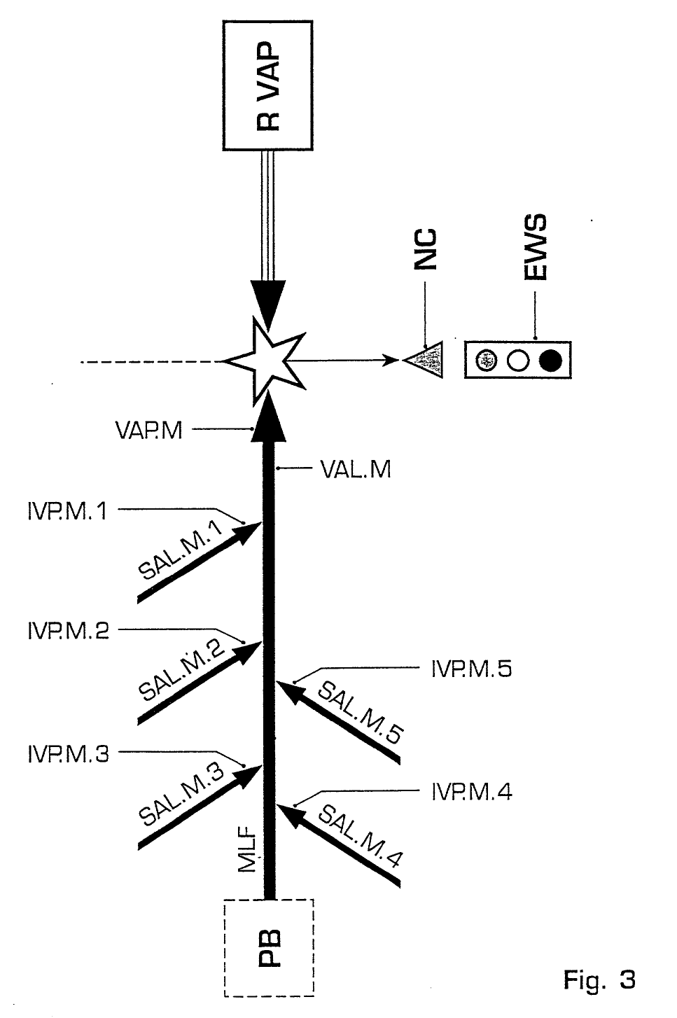

The invention is explained in more detail below using an exemplary embodiment illustrated in the drawing. In detail, FIG. 1 shows the visualization according to the invention of the value assembly and the value flows in the case of the construction of a combined-cycle power plant. FIG. 2 illustrates the focusing on VALs of different hierarchy levels, and the flow of the associated value added packages in a generalized form. Finally, FIG. 3 shows the detailed design of a value assembly line.

### WAY OF IMPLEMENTING THE INVENTION

An example of a part of the value assembly process is illustrated in FIG. 1. At the end of a value assembly process is a combined-cycle power plant which comprises a gas turbine 2, a generator 1 driven by the gas turbine, a waste-heat steam generator 3, a steam turbine 4, a generator 5 driven by the steam turbine, and a water-steam cycle 6. This complete combined-cycle power plant, which is handed over to the customer, is the added value package VAP.N of the highest hierarchy level N. Of course, documentation, customer training and much more also belong to this value added package; however, for the sake of a clear schematic illustration no explanation of this has been given. The value added package VAP.N is generated by the value assembly line VAL.N of the highest hierarchy level N. Value packages, specifically in this example the six components, cited above, of the combined-cycle power plant, are transferred into the value assembly line VAL.N. The components 1 to 6 are transferred as IVPs from the lower-order value assembly lines SAL.N, and assembled in the value assembly line VAL.N to form a value added package VAP.N. The value assembly lines of the lower-order hierarchy levels are explained with the aid of the value assembly of the subunit 4 “steam turbine”. On the hierarchy level N, the subunit 4 “steam turbine” is transferred from a lower-order value assembly line SAL.N.4 into the value assembly line VAL.N of the highest hierarchy level N. It is possible in a more detailed approach to focus on the lower-order value assembly line SAL.N.4. This is visualized on the hierarchy level N-1 as the value assembly line VAL.N-1.4 of the hierarchy level N-1. The steam turbine is generated in this value assembly line from the value packages 4.1 “stator upper part”, 4.2 “stator lower part” and 4.3 “rotor” as a value added package which serves, in turn, as input value package on the higher hierarchy level. The input value packages 4.1, 4.2 and 4.3 are supplied, in turn, by lower-order value assembly lines SAL.N-1.4.1, SAL.N-1.4.2 and SAL. N-1.4.3. It is possible, in turn, to focus on a lower-order value added assembly line of the hierarchy level N-1. In such a once again focused approach, a lower-order value assembly line SAL.N-1 of the hierarchy level N-1 is visualized as a value assembly line VAL.N-2 of the hierarchy level N-2. In the figure, a value assembly line VAL.N-2 of the hierarchy level N-2 is visualized, in which a rotor is produced from a shaft 4.3.1 and blades 4.3.2.

This is illustrated in FIG. 2 in a generalized mode. Value assembly lines VALs are visualized as arrows at whose tips value packages—machine components, money, quality, information and the like—are transferred as VAPs. On a highest hierarchy level N, a value assembly line VAL.N receives input value packages from lower-order value assembly lines SAL.N. A lower-order value assembly line SAL.N.1 is focused on. On one hierarchy level N-1, this takes the form of the value assembly line VAL.N-1.1, with a number of lower-order value assembly lines SAL.N-1. Again, it is possible to focus on one of these lower-order value assembly lines, for example SAL.N-1.1.2 which, in turn, is presented on the hierarchy level N-2 in a completely analogous way as the added value assembly line VAL.N-2. Thus, on each hierarchy level the value assembly of lower-order value assembly lines can be visualized in turn as value assembly lines on a lower hierarchy level as a secondary works in this lower-order value assembly line. In this case, upon transition from one hierarchy level to the other, or from one branch to the other there is certainly a change in this process in the contents of the individual branches, but the structure always remains similar on each hierarchy level and in each branch. The value assembly process is therefore visualized as a fractal structure when the invention is applied consistently. A further basic property of this visualization is that the individual value assembly lines of a hierarchy level have no interfaces with one another, and therefore proceed independently of one another. VAPs in the actual state are visualized as circles on the right-hand side of the figure. In the example, these value packages contain the information items of money $, components X and quality Q. A further important item of information is certainly time; but different types of information or values can also be relevant depending on the project. VAPs are transferred along the arrows vertically in one direction, always to the higher hierarchy level. Horizontal value and information flows, that is to say an interchange of value and/or information between the VALs of a hierarchy level do not exist. Moreover, desired values of the VAPs are illustrated as rectangular boxes in reference VAPs, RVAP. A comparison is made in each case between the desired and actual values of the VAPs, that is to say between VAPs and RVAPs, at the points marked with stars within the value assembly process, and therefore at the interfaces between the VALs and SALs. Critical deviations can already be detected in this case on low hierarchy levels, and therefore also in early project phases, and appropriate countermeasures can be taken early.

This is illustrated in FIG. 3 with the aid of an arbitrarily selected value assembly line VAL.M of any desired hierarchy level M. VAL.M receives input value packages from lower-order value assembly lines SAL.M.1, SAL.M.2, . . . , SAL.M.5. Since it is of fundamental importance for the invention, it is pointed out once again that the SALs SAL.M are visualized on a lower hierarchy level M-1 in a completely analogous fashion as VAL.M-1. The VAL VAL.M generates from the input value packages IVP, which for their part visualize VAPs of the SALs, a value added package VAP, which is visualized here as an arrow tip. The VAP receives the information passed on to a higher-order hierarchy level or to an output unit in a standardized transfer format, for example in the form of a list. A comparison with a reference value added package RVAP takes place at the output interface. The RVAP contains desired values of the VAP as reference data. The EWS triggers an alarm message in the event of critical deviations NC such as cost runovers or missed deadlines, a high proportion of rejects in a production run, or other desired value deviations which can entail a lasting disturbance of the value assembly. Disturbances of critical processes can therefore be detected at an early stage and localized, and remedial measures taken. Here, the illustration of the value assembly process according to the invention has a further advantage that, on the basis of the simulation of the overall value assembly process, a small deviation which does not yet lead to a disturbance on a lower-order plane can be investigated as to whether this deviation results on a higher-order hierarchy level in effects critical to success.

FIG. 3 further indicates an example of how the illustration according to the invention of a value assembly process can be implemented as a computer program. The VAL, which is illustrated as a thick black arrow, is generated in the example from an identical source code on all hierarchy levels. At the base of the arrow, the program code receives specific values from a parameter block PB in a suitable way either upon the generation of the executable code or during the program run. Methods for combining the specific parameter block with the generic program code are already familiar to the person skilled in the art in the field of computer programming. For each individual VAL, that is to say for each branch and each hierarchy level, the parameter block PB contains specific information on which IVPs are to be read in, and on the way in which these are to be combined to form the VAP. Thus, in the true sense the parameter block PB generates the control and coordination function MLF inside the added value assembly line VAL. To this extent, the parameter block PB also makes a value contribution. It is therefore possible to use the self-similar visualization of the value assembly process to maintain and expand very quickly and efficiently a computer program which visualizes said process, even when different routines of this program system run in globally distributed computers. When the parameter blocks which define the combination of the individual subprocesses among one another remain unchanged, it suffices for the source code of the routines which are to illustrate a VAL to be changed once, and to distribute said routines, for example via the Internet, to the various computers of the local production units, the subcontractors, etc. The parameter blocks PB, which are stored in the local computers, ensure the specific adaptation of the routines to the locally executed processes during generation of the executable code, or else during the execution of the routine. Thus, the parameter block could be an include file such as is read into the source code during compilation of a program in a customary way known per se, and defines the constants and parameters, which are specific to the subprocess, for example, and control the program run. A logic connection to a control file to be read in during the run time could also exist. These methods, and a multiplicity of methods which act in a completely equivalent fashion with reference to the invention are very familiar to the person skilled in the art in the field of programming technology.

Of course, the parameter block PB can also prompt an IVP to be read, for example, by an input unit of absolutely any type, that is to say a scanner or a keyboard.

The task of the parameter block PB is, in general terms, to define the control and coordination function. To this extent, the parameter block also constitutes in the form of a main line function MLF an added value into the value assembly chain. Furthermore, the parameter block defines the practically required break in the self-similarity on a lowermost hierarchy level when the IVPs are not supplied by a further SAL, but are transferred by input units to the input interfaces of the VAL.

A parameter block can also prompt the VAP of the respective VAL to be output on an output unit such as a printer, display screen and the like.

The parameter block can prompt a VAP to be output onto a specific file, onto a specific data medium or onto a specific long distance data line, and make it accessible for a specific VAL of a higher hierarchy level.

The parameter block can determine the desired values of an RVAP with which the VAL is compared.

The parameter block can determine a permissible deviation between the VAP and RVAP.

The parameter block can determine the action which the EWS triggers upon overshooting of this tolerance value.

The parameter block can determine the point at which the EWS reports an impermissible deviation NC.

The parameter block determines the SALs from which a VAL fetches the IVPs, and the way in which these are combined with one another.

With the aid of these examples, it is evident at once to the person skilled in the art which options are available to him with the tool of the parameter block PB, specifically that it defines the actual subprocess inside the VAL when the invention is implemented in a computer program.

In this case, the invention also permits ways of visualizing the process for the user which are transparent in a very particularly advantageous fashion. In accordance with the visualization in FIG. 2, a user has displayed on his screen in each case only one hierarchy level, for example in the form of the thick arrow illustrated there, which visualizes the VAL, and in the form of the thinner arrows, which visualize the SALs of this hierarchy level. Of course, in this case it is also possible to undertake color distinctions, or distinctions in the way of visualizing the arrows which represent the SALs. If, now, the user is located on a hierarchy level N in the case of the example in FIG. 2, he is presented with the rectangle marked with “N” in FIG. 2. In order to analyze the value flows, the user can easily select a lower-order value assembly line SAL.N with the aid of a pointing device, for example a mouse. Consequently, the mode of visualization changes. The user now sees the rectangle marked with “N-1”. As described repeatedly above, the lower-order value assembly line SAL.N.1, which is focused on in the example, is now visualized on the hierarchy level N-1 as value assembly line VAL.N-1.1, in a similar way as previously the value assembly line VAL.N in the visualization of the hierarchy level N. Because of the fractal visualization, this procedure can be pursued to hierarchy levels of any desired depth. Conversely, the user is guided directly to the next higher hierarchy level by the selection of the VAL, that is to say the thick arrow. A user is therefore capable very easily of following value flows within a complex project in two directions.

Impermissible specification deviations NC can advantageously be visualized by, for example, using the color of the visualization to emphasize all the subprocesses, represented as arrows in the example here, which are affected by the specification deviation. A user who is made aware on an uppermost level of deviations by the variation in the color of his VAL can then in a particularly simple way trace back to the origin of the deviation the arrows marked in a warning color, and test and optimize counter-measures by means of the process simulation before he implements these in the real value assembly process.

In the visualization selected in FIG. 2, the user also has the option of using the pointing device on the output unit to select the symbol of the value added package VAP in order to obtain a visualization of the latter.

Furthermore, the user can also open a view of the reference value added package, or also process the latter. Likewise, he can obtain access to the desired actual value comparison by selecting the star on his display screen.

Particularly when the program is running on distributed systems and with a multiplicity of users, each user advantageously receives individual rights to access and modify transmitted information. Thus, for example, it should be avoided that a user, who is the POT on a lower hierarchy level, can change reference value added packages of a higher hierarchy level, or that he has access to other subprocesses on the same hierarchy level. It is also possible to determine that a user has access only to a portion of the information content of a value added package. Such authorization systems, which are familiar to the person skilled in the art from the modern operating system architecture, are advantageously implemented as required when implementing the invention as a computer program.

When the value added packages are visualized on an output unit—display screen, printer, file or similar—it will also be advantageous when specific views are predefined there which reproduce only a portion of the information content of a value added package, or else combine selected information from a plurality of value added packages. Thus, for example, a view of all value added packages of the same type could be reproduced on a specific hierarchy level at a specific instant. For a large combined-cycle power plant, this would mean, for example, that the state of all the gas turbines or all generators at a specific instant is reproduced. In another view, a value added package could be visualized as a combination of all lower-order value added packages—thus, for example, a turbine could be visualized as the sum of rotor and stator.

The exemplary embodiments visualized above may not, of course, in any way be used to limit the scope of protection characterized in the claims. In the light of the description of the invention, the person skilled in the art is, of course, entirely capable of implementing a multiplicity of further exemplary embodiments of the invention.

List of Reference Symbols

EWS Warning function

IVP Input value packages

NC Deviation

RVAP Reference value added package

SAL Sub assembly line

VAL Value assembly line

VAP Value added package

1. A method for visualizing and processing a value assembly process, the value assembly process being visualized as a set of value assembly lines (VAL), which value assembly lines are arranged on a number of different hierarchical levels, the value assembly lines having the following essential properties:
each value assembly line has precisely one output interface and at least one input interface;
the value assembly line receives input value packages (IVP) via the input interfaces;
the input value packages are combined in the value assembly line in accordance with rules defined in a specific main line function (MLF), a value contribution being made, and the value added package (VAP) being generated;
the value added package is made available via the output interface; and
similar types of information are contained in the input value packages and in the value added package;
the process visualization having the following basic properties:
an uppermost hierarchy level (N) has precisely one value assembly line (VAL.N) of the highest hierarchy level, which generates a value added package (VAP.N);
the value assembly line of the highest hierarchy level receives input value packages (IVP) via its input interfaces from lower-order value assembly lines (SAL.N);
when a lower-order value assembly line (SAL.N) is focused on, it is visualized in an entirely similar way as a value assembly line (VAL.N-1) which receives its input value packages from lower-order value assembly lines (SAL.N-1) and whose value added package (VAP.N-1) is provided as input value package for the value assembly line of the uppermost hierarchy level (VAL.N); and
on each hierarchy level (M) down to a lowermost hierarchy level it is possible in each case to focus on a lower-order value assembly line (SAL.M) of this hierarchy level, which is visualized in a similar way as a value assembly line (VAL.M-1) of the next lower hierarchy level (M-1), which likewise receives input value packages via input interfaces, combines these, makes a value contribution, and makes a value added package (VAP.M-1) available at the output interface;
in such a way that the process is visualized as a fractal process in the case of which the structure of all value assembly lines is similar on all hierarchy levels,
value packages being processed in accordance with the following steps:
on a lowermost hierarchy level, value packages (IVP) are supplied to the value assembly lines (VAL) of the lowermost hierarchy level across the system boundaries of the value assembly process under consideration;
the input value packages (IVP) of a lowermost hierarchy level are combined in value assembly lines (VAL) of this lowermost hierarchy level in accordance with its main line function (MLF), the value of the value packages is increased by a value contribution of the value assembly line and/or of the main line function, and a value added package (VAP) is made available at the output interface of the value assembly line;
on all hierarchy levels up to a highest hierarchy level, the value added package (VAP) is passed on to precisely one value assembly line (VAL) of the next higher hierarchy level, and serves this value assembly line as input value package;
the value flows take place strictly in one direction, in each case from a lower hierarchy level into a higher hierarchy level, and the value assembly lines of a hierarchy level are not interconnected.

2. The method as claimed in claim 1, in which each value added package (VAP) is compared with a reference value added package (RVAP), and in which impermissible deviations of the value added package (VAP) and of the reference value added package (RVAP) are detected and reported via a warning function.

3. A Computer program for simulating and illustrating a value assembly process, the process comprising a number of self-similar value assembly lines which are arranged on different hierarchy levels and are independent of one another on a hierarchy level, in which value assembly process value packages are transferred in each case from a value assembly line of a lower-order hierarchy level into a value assembly line of a higher-order hierarchy level, input value packages being combined in each value assembly line, a value contribution being made, and a value added package being generated, which computer program includes
machine-readable instruction sequences of a first, higher-order hierarchy level, which prompt a computer to read in data from at least one data form and to combine these data using specific combining rules, and to store the output data thus determined in a data form on a computer-readable storage medium and/or an output medium;
mutually independent machine-readable instruction sequences of at least one further hierarchy level of lower order than the first hierarchy level, which instruction sequences prompt a computer to read out data at least from a number of data forms, to combine them with one another, and to store the results of combination in an output data form of this hierarchy level in each case; and
machine-readable instruction sequences which prompt a computer to read data into input data forms from an input unit;
in which the data forms, which are being read on a specific hierarchy level during the program run, are output data forms of a hierarchy level of lower order than this hierarchy level, or input data forms:
in which all data forms have a standardized data format in such a way that all output data forms which are generated during the run of instruction sequences on an arbitrary hierarchy level, and all input data forms have a common data structure, that is to say data which are of one information type are always stored in the same position in a form;
and in which all different machine-readable instruction sequences of all different hierarchy levels are generated from identical source codes from which instructions for reading in the specific data forms and relating to the specific combinations are created by a specific parameter file either during generation of the sequences which can be executed, or during the running time of the computer program.

4. The computer program as claimed in claim 3, in which the data contained in the forms constitute input value packages (IVP) and value added packages (VAP) of the value assembly process.

5. The computer program as claimed in one of claims 3 or 4, in which the data generated by an instruction sequence are classified according to their qualitative information content and stored in different classes of standardized data forms.

6. The computer program as claimed in one of claims 3 to 5, in which during execution of the computer program or individual sequences of the computer program the generated value added packages (VAP) are compared with a reference value added package (RVAP) in each case, which reference value added package contains specification data, and in which a report is made via a warning function (EWS) in the event of impermissible specification deviations (NC).

7. The computer program as claimed in one of claims 3 to 6, in which machine-readable sequences of different value assembly subprocesses run on different computers, and data forms are transferred via long-distance data lines.

8. A method for visualizing a value assembly process on an output unit of a computer system, the process comprising a number of self-similar value assembly lines which are arranged on different hierarchy levels and are independent of one another on a hierarchy level, in which value assembly process value packages are transferred in each case from a value assembly line of a lower-order hierarchy level into a value assembly line of a higher-order hierarchy level, input value packages being combined in each value assembly line, a value contribution being made, and a value added package being generated, the computer system including, inter alia, a central processing unit and a pointing device in addition to the output unit,
in which method a value assembly line (VAL.M) of one hierarchy level is visualized in each case on the output unit, said value assembly line being visualized as an arrow at the tip of which a value added package (VAP.M) is transferred, and lower-order value assembly lines (SAL.M) which are value assembly lines of a lower-order hierarchy level, are likewise visualized as arrows the tips of which are applied to the shaft of the arrow which visualizes the value assembly line of the higher-order hierarchy level,
it being possible for the user of the computer system to use the pointing device to select a lower-order value assembly line and to focus on the latter in such a way as to visualize it in the focused visualization in the same way as the value assembly line of the higher-order hierarchy level as an arrow with smaller arrows running up to it, and it being possible for the user to use the pointing device to select the arrow tip of the value assembly line, whereupon the value assembly line of the higher-order hierarchy level is visualized in a similar way and such that the path of an integral part of the value assembly process firstly can be traced back without difficulty to its origin from a higher hierarchy level, and the contribution of this integral part to the overall value assembly process can be traced through all hierarchy levels.

9. The method as claimed in claim 8, in which a computer program in accordance with one of claims 3 to 7 runs in the central processing unit of the computer system.

10. The method as claimed in one of claims 8 or 9, in which the arrows of value assembly processes which make different value contributions are visualized with the aid of different colors and/or line thicknesses.

11. The method as claimed in one of claims 8 to 10, in which a computer program in accordance with claim 6 runs in the central processing unit of the computer system, and in which the warning function prompts the computer system to display on the output unit an impermissible value deviation occurring on an arbitrary hierarchy level, and all arrows which visualize value assembly lines which are affected by the value deviation are visualized in a particularly emphatic type of visualization on the output unit in such a way that the impermissible deviation can be traced back immediately to its origin from a higher hierarchy level.

12. A computer program which includes instruction sequences which prompt a computer to execute the method steps according to one of claims 8 to 11.

13. A computer system for carrying out a program according to one of claims 3 to 7.

14. A computer program product in which instruction sequences of the program are stored on a computer-readable medium in accordance with one of claims 3 to 7.

15. A computer program product in which instruction sequences of the program are stored on a computer-readable medium in accordance with claim 12.
